(19) United States
(12) Patent Application Publication
(10) Pub. No.: US 2012/0236539 A1
(43) Pub. Date: Sep. 20, 2012

(54) LIGHT GUIDE PLATE, LIGHT SOURCE DEVICE, AND DISPLAY DEVICE

(75) Inventors: Masataka Shiratsuchi, Kanagawa-ken (JP); Takeshi Morino, Kanagawa-ken (JP); Yoshinori Honguh, Kanagawa-ken (JP)

(73) Assignee: KABUSHIKI KAISHA TOSHIBA, Tokyo (JP)

(21) Appl. No.: 13/222,145

(22) Filed: Aug. 31, 2011

(30) Foreign Application Priority Data
Mar. 16, 2011 (JP) 2011-058317

(51) Int. Cl. G09F 13/04; F21V 5/00; F21V 7/00; F21V 11/00

(52) U.S. Cl. 362/97.1; 362/355; 362/311.06; 362/296.01

(57) ABSTRACT

A light guide plate comprising a flat-plate member provided with a first surface including a flat surface portion and a recessed portion in a conic-like solid shape and a second surface opposed to the first surface, the flat-plate member configured to receive light from the recessed portion, to propagate the light inside the flat-plate member while diffusing the light, and to radiate the diffused light from the second surface, wherein an angle between an inclined surface of the recessed portion and a normal line to the flat surface portion is smaller than a value obtained by calculation in which twice a critical angle where the light is totally reflected by the second surface inside the flat-plate member is subtracted from 90°.

### CROSS-REFERENCE TO RELATED APPLICATION

This application is based upon and claims the benefit of priority from Japanese Patent Application No. P2010-058317, filed on Mar. 16, 2011; the entire contents of which are incorporated herein by reference.

### FIELD

Embodiments of the present invention relate to a light guide plate, a light source device, and a display apparatus.

### BACKGROUND

Light source devices used for display or other similar apparatuses are roughly classified into a direct lighting type and an edge lighting type. The direct lighting type is provided with multiple light sources placed on all over an entire surface of a light source substrate constituting a light source device, and radiates light out of the device by diffusing light emitted from the light sources. The edge lighting type includes a light guide plate provided with a light source at an end portion of the light guide plate. In the edge lighting type, light emitted from the light source is total internally reflected on upper and lower surface of the light guide plate and thus propagated inside the light guide plate and light incident onto scattering marks formed at portions of the light guide plate is diffused and radiated out of the device.

However, a direct lighting type light source device has a problem that luminance right above a light source is higher than other places because part of the light from the light source is radiated directly out of the device from that place.

### BRIEF DESCRIPTION OF THE DRAWINGS

FIG. 1 is a cross-sectional view of a light source device according to a first embodiment.

FIGS. 2A and 2B are configuration diagrams of a light guide plate of the light source device according to the first embodiment.

FIG. 3 is a schematic diagram of a light beam inside the light guide plate.

FIGS. 4A and 4B are views showing a result of a simulation using the light guide plate of the light source device according to the first embodiment.

FIGS. 5A and 5B are views showing a result of a simulation not using the light guide plate of the light source device according to the first embodiment.

FIGS. 6A and 6B are views for explaining an effect of the light guide plate.

FIG. 7 is a view for explaining diffusion of a light beam.

FIG. 8 is a view for explaining reflection of the light beam by a reflector.

FIG. 9 is a view for explaining reflection of the light beam by a reflection member.

FIG. 10 is a cross-sectional view of a light source device according to a second embodiment.

FIGS. 11A and 11B are configuration diagrams of a light guide plate of the light source device according to the second embodiment.

FIG. 12 is a top view of a light source device according to a second embodiment.

FIG. 13 is a configuration diagram of a display apparatus of an applied example.

FIG. 14 is a schematic diagram of the display apparatus of the applied example.

### DETAILED DESCRIPTION

It is to provide that a light guide plate, alight source device, and a display apparatus which are capable of homogenizing in-plane luminance distribution of light to be taken out of the device and apparatus.

A light guide plate according to an aspect of embodiments includes: a flat-plate member provided with a first surface including a flat surface portion and a recessed portion in a conic-like solid shape and a second surface opposed to the first surface, the flat-plate member configured to receive light from the recessed portion, to propagate the light inside the flat-plate member while diffusing the light, and to radiate the diffused light from the second surface, wherein an angle between an inclined surface of the recessed portion and a normal line to the flat surface portion is smaller than a value obtained by calculation in which twice a critical angle where the light is totally internally reflected by the second surface inside the flat-plate member is subtracted from 90°.

A light source device according to one aspect of embodiments includes the light guide plate, and a light source provided right below the recessed portion and configured to emit light which then enters the light guide plate from the recessed portion.

A display apparatus according to one aspect of embodiments includes the light source device.

Further detailed embodiments will be described below.

### First Embodiment

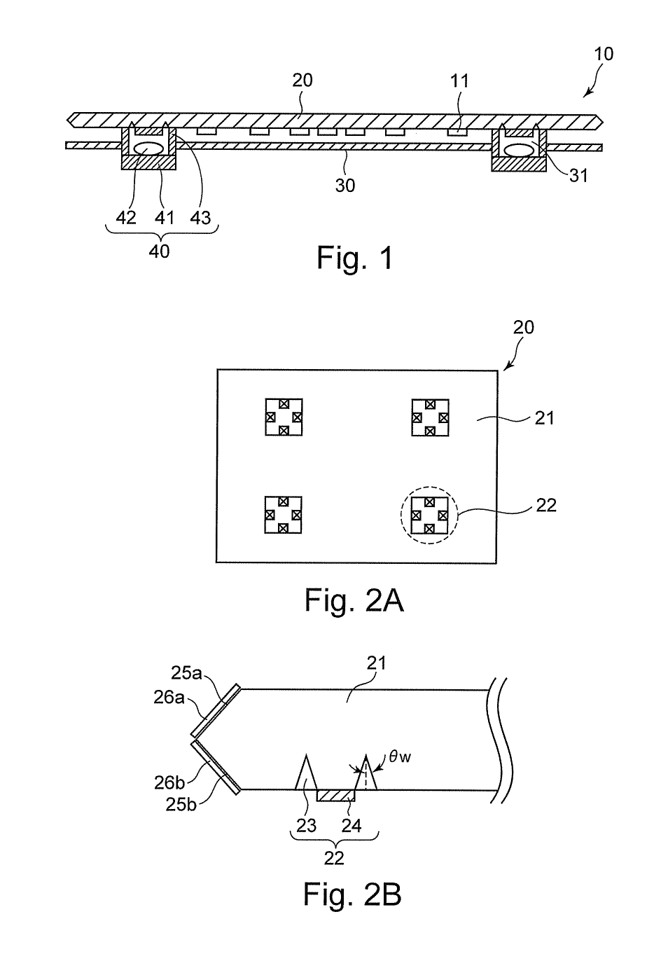

A configuration of a light source device 10 according to a first embodiment of the present invention will be described below with reference to FIG. 1 to FIG. 10.

FIG. 1 is a cross-sectional view of a light source device 10. The light source device 10 includes a flat light guide plate 20, a reflector 30 provided to be opposed to the light guide plate 20 and having opening 31, light source units 40 provided inside the openings 31 on the reflector 30, and diffusing portions 11 provided on a reflector 30 side of the light guide plate 20 and configured to diffuse light. Each light source unit 40 includes a base plate 41, a light source 42 provided on the base plate 41, and a light shield plate 43 surrounding the light source 42. The following description will be based on the assumption that the light guide plate 20 is located on an upper side while the reflector 30 is located on a lower side.

The light guide plate 20 is a sheet-like flat plate configured to propagate light thereinside. The light emitted from the light source 42 enters the light guide plate 20 from a lower surface of the light guide plate 20 and is propagated inside the light guide plate 20. Then, part of light diffused inside the light guide plate 20 is taken out from an upper surface of the light guide plate 20. This light guide plate 20 is preferably made of a transparent material such as an acrylic resin.

The reflector 30 is a sheet-like flat plate made of a material which reflects light (by means of specular reflection or diffuse reflection). The reflector 30 includes the openings 31, and the light source units 40 to be described later are provided in these openings 31. The light emitted from the light source 42 of each light source unit 40 passes through this opening 31 and is radiated on the light guide plate 20 on the upper side.

The light source unit 40 includes the base plate 41, and the light source 42 such as an LED (light emitting diode) is provided on this base plate 41. Moreover, the light shield plate 43 is provided so as to surround the light source 42, on an outer periphery of the base plate 41. This light shield plate 43 is formed so as to contact an inner periphery of the opening 31 provided on the reflector 30.

This light shield plate 43 can prevent leakage of the light emitted from the light source 42 and radiate the light upward through the opening 31. The light shield plate 43 may be made of a similar material to that of the reflector 30 configured to reflect the light.

The diffusing portions 11 are provided on the lower surface of the light guide plate 20 and are formed by means of serigraph to coat white ink or incision, for example. The light incident on the diffusing portions 11 is diffused and radiated out from the upper side of the light guide plate 20.

These diffusing portions 11 are arranged sparsely in a region close to the light source 42 and arranged gradually densely with distance from the light source 42. In this way, the diffusing portions 11 are appropriately arranged so that luminance distribution of the light passing through the light guide plate 20 can be substantially equalized over the entire surface of the light guide plate 20. A detailed layout can be determined in advance based on intensity or layout positions of the light sources 42.

In the light source device 10 of this embodiment, the light source units 40 are provided partially in minimum required regions in order to achieve necessary luminance which is predetermined as the light source device 10 instead of providing the light source units over the entire surface right below the light guide plate 20. For this reason, it is possible to reduce a thickness of a casing in positions other than these light source units 40 and thereby to make most part of the device thinner. Moreover, since it is not necessary to provide light sources on edge surfaces of the light guide plate 20, it is possible to reduce frame widths of the casing.

Now, a configuration of the light guide plate 20 will be described in detail with reference to FIGS. 2A and 2B.

FIG. 2A is a top view of the light guide plate 20 and FIG. 2B is a side view of the light guide plate 20.

Each end portion of the light guide plate 20 is formed in a mountain-peak shape having an apex angle of 90° C. (an upper side surface and a lower side surface thereof are denoted by reference numerals 25a and 25b, respectively). Reflection members 26a and 26b such as silver foils are attached to these side surfaces 25a and 25b of the end portion so as to form reflection surfaces.

The lower surface of the light guide plate 20 has four regions (hereinafter referred to as a light incident region 22), each of which has four quadrangular pyramid-like shaped recessed portions arranged closely to one another at an appropriate interval in an appropriate direction. The light source units 40 are located right below these light incident regions.

Moreover, in order to allow the light emitted from the light source 42 of the light source unit 40 to be incident only on the recessed portion of the light incident region 22 but not on a flat surface portion, a light shielding portion 24 configured to reflect the light is provided on the flat surface portion 24. When the light from the light source 42 is irradiated on portions other than the recessed portions, the light is reflected inside the light source unit 40 and is radiated intensively onto the recessed portions.

If the light that enters the light guide plate 20 from one of the four recessed portions hits a side surface of another recessed portion, the light may be scattered and leak out of the light guide plate 20. For this reason, these four recessed portions are arranged in such a manner that each two closest adjacent recessed portions face each other, not at their sides of the rectangular bases of the quadrangular pyramids, but at their vertices of the rectangular bases, as shown in FIGS. 2A and 2B, in order to sufficiently reduce interferences among the recessed portions. Note that, with the apexes of the quadrangular pyramids of the two adjacent recessed portions fixed, the vertices of the bases are arranged on a straight line connecting the centers of the bases to minimize the distance between the vertices.

Although this embodiment describes the recessed portions in the shape of quadrangular pyramids as the example, the recessed portions may be any types of conic-like solid shapes. Specifically, the recessed portions may be formed into any of multiple-sided geometrical pyramid shapes other than quadrangular pyramid shape or into a conical shape. In addition, the light incident region 22 may also be formed of a combination of recessed portions including one or more types of multiple-sided geometrical pyramids and cones.

Moreover, the end portion of the light guide plate 20 may be formed into a flat side surface instead of the peak shape. In this case, the reflection surface is formed by attaching a silver foil or a white seal in the same way as the case of the above-described peak shape.

According to the light guide plate 20 of this embodiment, theoretically almost all of the light incident on inclined surfaces of the quadrangular pyramids constituting the above-described light incident regions 22 and entering the light guide plate 20 is propagated inside the light guide plate 20 while repeating total internal reflection. In this way, the light entering the light guide plate 20 from the partially provided light incident regions 22 is propagated over the entire inside of the light guide plate 20.

Therefore, this embodiment is characterized in that the apex angle of the recessed portion of each of the quadrangular pyramids constituting the light incident regions 22 has a requirement as a condition for achieving the total internal reflection of theoretically all of the light incident on the inclined surfaces inside the light guide plate 20 as described above.

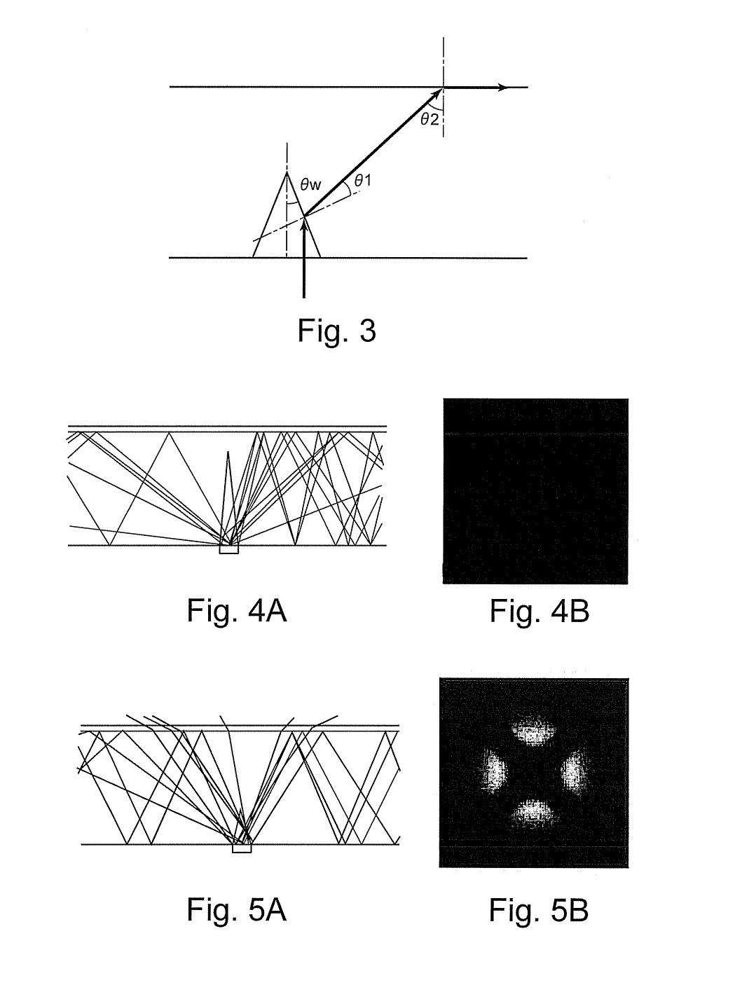

Now, the requirement of the apex angle of the recessed portion will be described below in detail with reference to a schematic diagram of a light beam shown in FIG. 3. Here, n denotes a refractive index of the material constituting the light guide plate 20; θw, an angle between the inclined surface of the recessed portion and a normal line perpendicular to the upper surface (the surface side without the recessed portion) of the light guide plate 20, i.e., a half of the apex angle of the recessed portion; and θc, a critical angle above which a light beam, which is to be radiated out of the light guide plate 20 to the air, is totally internally reflected inside the light guide plate 20.

Here, assuming that the refractive index of the air is equal to 1, then the above-described critical angle θc is given by the following formula according to the Snell's law. Note that arcsin represents the inverse sine.

θc=arcsin(1/n) (formula 1)

A relationship among a refraction angle θ1 (an angle between a normal line to the inclined surface and refracted light) of a light beam emitted from the light source 42 and entering the light guide plate 20 from the inclined surface of the recessed portion, an incident angle θ2 (an angle between the normal line to the light guide plate 20 and incident light) inside the light guide plate 20, and the above-described angle θw is expressed by the following formula.

θ1+θ2+θw=90° (formula 2)

In addition, a light beam entering in parallel to the inclined surface of the recessed portion is refracted at the refraction angle θc inside the light guide plate 20 according to the above-described Snell's law. Therefore, the light beam entering the light guide plate 20 from the inclined surface of the recessed portion is always refracted at a refraction angle equal to or below the critical angle θc with respect to the normal line to the inclined surface. In this way, the following formula expresses a relationship between the refraction angle θ1 and the critical angle θc.

θ1<θc (formula 3)

Further, as a condition to cause the total internal reflection of the light beam, which is to be radiated out of the light guide plate 20 to the air, the incident angle θ2 and the critical angle θc need to satisfy a relationship as expressed by the following formula.

θ2>θc (formula 4)

According to the formula 2 to formula 4 mentioned above, the angle θw between the inclined surface of the recessed portion and the normal line perpendicular to the surface of the light guide plate 20 should satisfy the following formula (hereinafter, the requirement) in order that the total internal reflection of the light beam entering the light guide plate 20 from the inclined surface of the recessed portion can occur inside the light guide plate 20.

θw<90°−2θc (formula 5)

Therefore, in this embodiment, each of the recessed portions is formed in accordance with the above-described requirement so that the angle between the inclined surface of the recessed portion and the normal line perpendicular to the surface of the light guide plate 20 can be smaller than the value obtained by calculation in which twice the critical angle above which the light beam, which is to be radiated out of the light guide plate 20, is totally internally reflected inside the light guide plate 20, is subtracted from 90°.

By forming the recessed portions of the light incident regions 22 meeting the requirement as defined by the formula 5, theoretically all of the light entering the light guide plate 20 from the light incident regions 22 is totally internally reflected and propagated inside the light guide plate 20.

As a result, the light emitted from the light source 42 is avoided from being directly radiated out of the light guide plate 20, and the luminance right above the light source 42 is reduced. For this reason, the device does not need to be provided any more with a thick diffusion plate or the like, which is conventionally used to reduce the luminance right above the light source 42, and thereby can be made thinner.

Here, when an acrylic resin having the refractive index of 1.49 is used as the material of the light guide plate 20, for example, the critical angle θc can be calculated as 45.12° based on the formula 1. Therefore, according to the requirement expressed by the formula 5, the angle θw should be smaller than 5.689° in order to allow theoretically all of the light entering the light guide plate 20 to be totally internally reflected and thereby propagated inside the light guide plate 20.

Specifically, by forming the light incident regions 22 with the recessed portions in the shape of the geometrical pyramid having the above-described angle θw smaller than 5.689° while using the acrylic resin having the refractive index of 1.49, theoretically all of the light entering the light guide plate 20 from these light incident regions 22 is totally internally reflected inside the light guide plate 20.

On the other hand, if the light incident regions 22 are formed with the recessed portions in the shape of the conic-like solid having the above-described angle θw larger than 5.689° while using the acrylic resin having the refractive index of 1.49, all of the light entering the light guide plate 20 from these light incident regions 22 is not totally internally reflected inside the light guide plate 20. Instead, some of the light is totally internally reflected while the rest of the light is directly radiated out of the light guide plate 20.

Next, an effect of the requirement of the apex angle of each of the geometrical pyramids will be shown in the form of simulations. FIGS. 4A and 4B show a result of a simulation when applying the requirement according to the formula 5, while FIGS. 5A and 5B show a result of a simulation when not applying the requirement according to the formula 5. Here, FIG. 4A and FIG. 5A are the simulation results showing aspects of the light beams inside the light guide plate 20 and FIG. 4B and FIG. 5B are the simulation results showing leakage of the light in a range of 10 mm×10 mm right above the light source 42.

Here, an acrylic board having the refractive index of 1.49, a thickness of 2.4 mm and a size of 30 cm each, is assumed to be used. A quadrangular conic-like solid-shaped recessed portion is provided at a central portion of this board and the light from the light source 42 is made incident thereon. A base of the recessed portion is designed as a square 0.4 mm on a side, and the apex angle is adjusted by changing a depth of the recessed portion.

When setting the apex angle 2θw=11.36° (the depth 2.01 mm), it is confirmed that the light leakage from the light guide plate 20 is completely prevented.

On the other hand, with the setting of the apex angle 2θw=30° (the depth 0.746 mm), it is shown that the light leaks out within a small region right above the light source as shown in FIGS. 5A and 5B. At the same time, the result shows that about 9.7% of an amount of the incident light leaks out.

As shown in the former case, when the light leakage is equal to zero, it is possible to illuminate the light guide plate evenly by appropriately arranging the diffusing portions 11. On the other hand, when the light leaks out within the small region right above the light source, it is difficult to correct the luminance distribution by means of the arrangement of the diffusing regions 11, and therefore annoying bright points appear in these small regions.

Hence, use of the light guide plate 20 of this embodiment having the requirement of the angle θw in accordance with the formula 5 makes all of the light totally internally reflected inside the light guide plate 20. Hence the light guide plate 20 of this embodiment has a significant effect as compared to an example with no appropriate requirement provided for the angle θw.

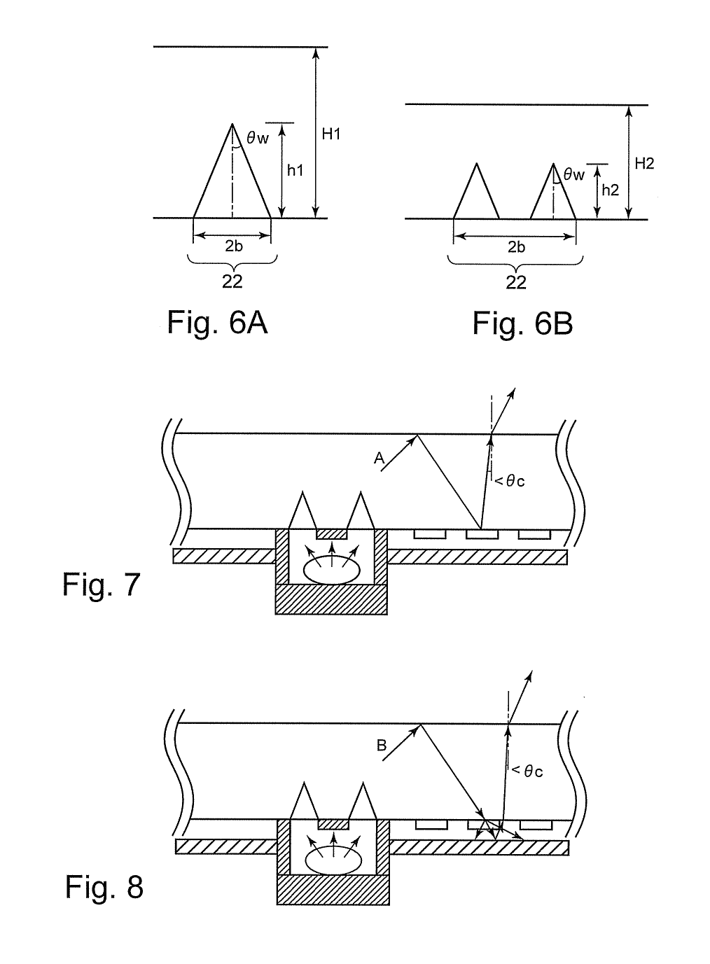

Moreover, each of the light incident regions 22 is formed by arranging multiple recessed portions in the pyramid shape. For example, when the light incident region 22 is formed of one recessed portion as shown in FIG. 6A, assuming that a width of the light incident region 22, or namely the recessed portion, is equal to 2b and a height thereof is equal to h1, then the height of the recessed portion can be expressed as h1=b/(tan θw) by use of the value θw calculated in accordance with the above-described requirement.

In contrast, when the light incident region 22 is formed of a plane surface portion and two recessed portions (in the width direction) in this embodiment as shown in FIG. 6A, assuming that a width of the light incident region 22 is equal to 2b, a height of the recessed portion is equal to h2 and a width of the plane surface portion is 2l, then the height of the recessed portion can be expressed as h2=(b−1)/(2 tan θw) by use of the value θw.

Here, if the width 2l of the flat surface portion is defined as a half of the width of the light incident region 22, or namely b and is assigned to the formula 7, the height is expressed by h2=b/(4 tan θw). Accordingly, it is confirmed that the requirement of the formula 5 is satisfied even by suppressing the height of the recessed portions to ¼ as compared to the case of forming only one recessed portion.

As described above, when forming the light incident region 22 having the same width by use of one or more recessed portions in the shape of the geometric pyramid having the same apex angle calculated in accordance with the aforementioned requirement, providing the light incident region 22 with multiple recessed portions as in this embodiment allows the height of each of the recessed portions to be reduced.

Therefore, when the size of the light source 42 has a requirement, it is possible to reduce the thickness of the light guide plate 22 by forming each of the light incident regions 22 using the multiple recessed portions as in this embodiment and thereby suppressing the height of each of the recessed portions.

Now, functions of the light source device according to the present invention will be described in detail with reference to FIG. 7 to FIG. 9.

The light emitted from the light source 42 enters the light guide plate 20 from the inclined surfaces of the recessed portions in the geometrical pyramid shape formed in the light incident region 22. In this embodiment, as described previously, the requirement as shown in the formula 5 is defined for the angle θw formed between the inclined surface of the recessed portion and the normal line perpendicular to the surface of the light guide plate 20. Accordingly, the light entering the light guide plate 20 is propagated inside the light guide plate 20 while repeating the total reflection.

At this time, part of the light beams totally internally reflected and propagated inside the light guide plate 20 are made incident on the diffusing portions 11 provided on the lower side of the light guide plate 20. Then, part of the light beams diffused by these diffusing portions 11 and made incident on the upper surface of the light guide plate 20 at an angle smaller than the critical angle θc are not totally internally reflected but radiated out of the light guide plate 20 (a light beam A in FIG. 7).

In this embodiment, the diffusing portions 11 are appropriately arranged in advance as described previously. Therefore, the in-plane luminance distribution of the light diffused by these diffusing portions 11 and radiated out from the upper surface of the light guide plate 20 is substantially equalized.

Moreover, the reflector 30 is disposed at the bottom of the light guide plate 20 so as to be opposed to the light guide plate 20. Part of the light beams entering the above-described diffusing portions 11 are made incident not on the upper surface of the light guide plate 20 but on the lower surface thereof, and are radiated out of the light guide plate 20.

In this way, the light beams radiated out from the lower surface of the light guide plate 20 is reflected by the reflector 30 back to the light guide plate 20 and is incident on the light guide plate 20. Then, part of the light incident on the upper surface of the light guide plate 20 at an angle smaller than the critical angle θc is radiated out from the upper surface of the light guide plate 20 (a light beam B in FIG. 8).

In this way, it is possible to reduce a light loss by reflecting the light leaking downward from the light guide plate 20 back to the upper side using the reflector 30. Accordingly, it is possible to utilize the light emitted from the light source 42 effectively.

Moreover, each end portion of the light guide plate 20 is formed in a mountain peak shape having the apex angle of 90° as described previously. Part of the light beams totally internally reflected and propagated inside the light guide plate 20 reach the side surface 25a or 25b at the end portion without entering the diffusing portions 11 located on the way.

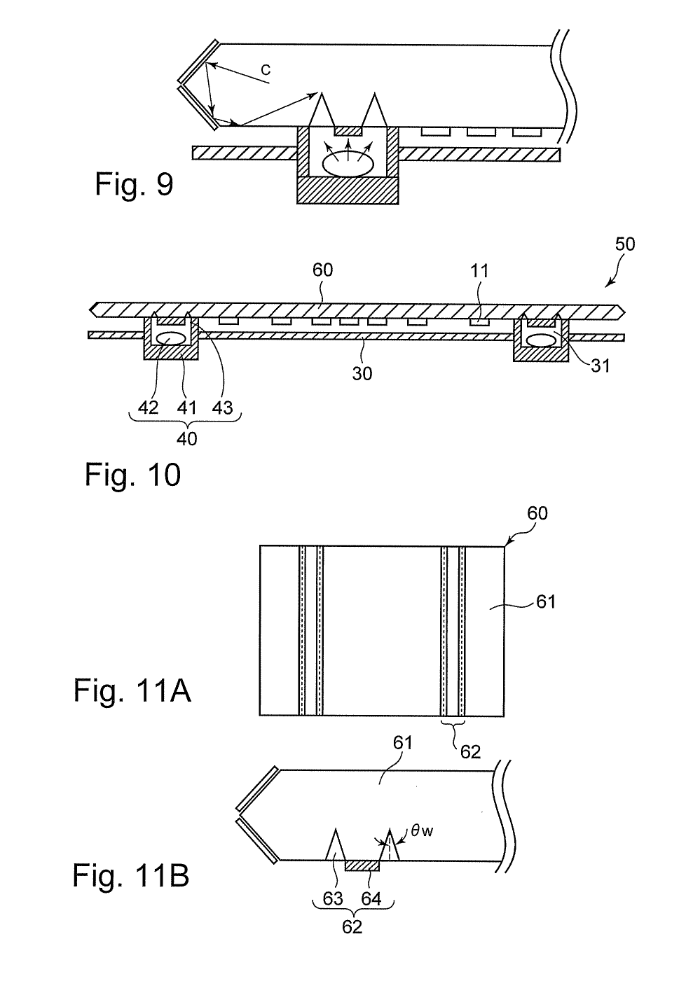

Then, the light beams reaching the end portion and being incident on the side surface 25a are totally internally reflected by the reflection member 26a to travel to the side surface 25b. Further, the light beams incident onto the side surface 25b from the side surface 25a are totally internally reflected by the reflection member 26b in a direction parallel to the above-described light beams traveling to the side surface 25a (a light beam C in FIG. 9).

In the same way, the light beams reaching the end portion and being incident on the side surface 25b are totally internally reflected by the reflection member 26b to travel to the side surface 25a. Further, the light beams incident onto the side surface 25a from the side surface 25b are totally internally reflected by the reflection member 26a in a direction parallel to the above-described light beams traveling to the side surface 25b.

Therefore, the light which is incident on the surface on the upper side or the lower side of the light guide plate 20 after two times of the internal reflection by the reflection members 26a and 26b as described above also satisfies the condition of the total internal reflection as defined by the formula 4 even in this state.

In this way, the light that reaches the end portions of the light guide plate 20 without being diffused by the diffusing portions 11 can be utilized again. Accordingly, it is possible to utilize the light effectively.

According to the light source device 10 of this embodiment, it is possible to make the device thinner and to reduce the luminance right above the light sources 42 by defining the angle requirement concerning the recessed portions constituting the light incident regions 22 of the light guide plate.

In this embodiment, it is to be noted that the concept of forming the recessed portion of the light incident region 22 into “the conic-like solid or the pyramid” also includes formation of a frustum by flattening a peak portion thereof. That is, a tilt angle of the inclined surface only needs to be provided with the requirement of the formula 5. In this case, however, the flat portion of the frustum is formed into a reflection surface by painting the surface in black using absorber, providing aluminum deposition, and the like.

### Second Embodiment

Alight source device 50 according to a second embodiment of the present invention will be described below with reference to FIG. 10 to FIG. 13. Note that portions which are the same as those in the first embodiment will be designated by the same reference numerals and description thereof will be omitted.

FIG. 10 is a cross-sectional view of a light source device 50. As similar to the first embodiment, the light source device 50 includes alight guide plate 60, a reflector 30, light source units 40, diffusing portions 11. The light source device 50 employs the light guide plate 60 which is different from the light guide plate in the light source device 10 of the first embodiment.

FIG. 11A is a top view of the light guide plate 60 and FIG. 11B is a side view of the light guide plate 60. In the light guide plate 20 of the light source device 10 according to the first embodiment, each of the light incident regions 22 is formed of the conic-like solid-shaped recessed portions. Instead, each of light incident regions 62 of the light guide plate 60 includes two recessed grooves extending parallel to a short side direction as shown in FIG. 11A. Each of these recessed grooves has a triangular cross section as shown in FIG. 11B. In this embodiment, an angle between an inclined surface of each of the recessed grooves and a normal line perpendicular to a surface of the light guide plate 60 satisfies the requirement of the formula 5.

In this way, as similar to the first embodiment, almost all of the light entering from these light incident regions 22 is totally internally reflected inside the light guide plate 60. Then, part of the light propagated inside the light guide plate 60 is diffused by the diffusing portions 11 whereby the in-plane luminance distribution of the light radiated out from the upper surface of the light guide plate 60 is substantially equalized.

Moreover, in this embodiment, the multiple light source units 40 are arranged along the light incident region 62. Switching or light amounts of the light sources 42 embedded in the light source units 40 can be independently controlled based on the light source units 40.

Here, as shown in FIG. 12, four light source units 40 are arranged along each two rows of the light incident regions 62. In this way, when the recessed grooves are arranged to extend in the short side direction, the light from the light source units 40 spreads mainly in a long side direction and is attenuated far from the light source units 40. The entire light source device 50 is configured to evenly emit light when all of the light source units 40 are turned on. Meanwhile, a region from which light is emitted when only one of the light source units 40 (such as a second one from the top on the left row in FIG. 12) is turned on is a region illustrated with diagonal lines in FIG. 12.

Therefore, by arranging the light source units 40 in two rows as described therein, it is possible to control lighting of eight regions independently of one another. In this way, it is possible to reduce luminance of the light source 42 of the light unit 40 corresponding to a dark portion of an image on a screen. Hence it is possible to achieve advantageous effects including improvement in a contrast ratio, reduction of power consumption, and so forth.

### Applied Examples

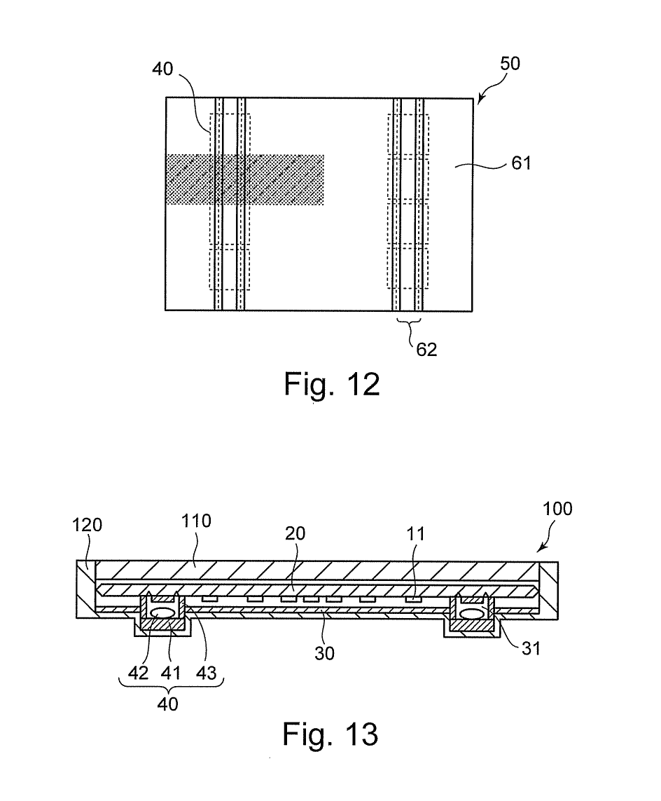

FIG. 13 is a configuration diagram of a display apparatus 100 employing the light source device 10 of the first embodiment.

The display apparatus 100 includes a liquid crystal panel 110 located above the light source device 10 and configured to display light from the light source device 10 as an image. The liquid crystal panel 110 and the light source device 10 are outfitted with a housing 120.

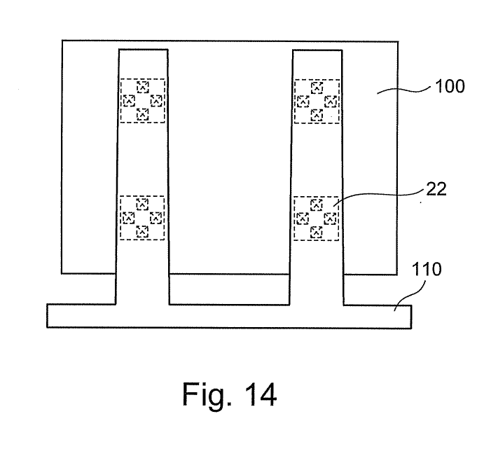

FIG. 14 is a schematic diagram of the display apparatus 100 further provided with pillars 130. These pillars 130 are arranged so as to overlap the light incident regions 22 illustrated with dotted lines. In this way, it is possible to make regions other than the pillar portions thinner.

According to the light source device of at least one of the embodiments described above, it is possible to equalize the in-plane luminance distribution of the light to be radiated out of the light source device.

It is to be noted that these embodiments describe certain examples and do not intend to limit the scope of the invention. These embodiments can also be embodied in various other aspects, and various omissions, replacements, and changes are possible without departing from the gist of the invention. These embodiments and modifications thereof are also encompassed by the scope and gist of the invention and are also encompassed by the invention and the range equivalent thereto which are defined by the appended claims.

Further, the conic-like solid shape in the embodiments may include a cone, a geometrical pyramid, a petrosal shaped dip or triangular shaped trench. The geometrical pyramid may be any sided pyramid such as three-sided pyramid, four-sided pyramid, six-sided pyramid, eight-sided pyramid or anymore.

What is claimed is:

1. A light guide plate comprising:
a flat-plate member provided with a first surface including a flat surface portion and a recessed portion in a conic-like solid shape and a second surface opposed to the first surface, the flat-plate member configured to receive light from the recessed portion, to propagate the light inside the flat-plate member while diffusing the light, and to radiate the diffused light from the second surface, wherein
an angle between an inclined surface of the recessed portion and a normal line to the flat surface portion is smaller than a value obtained by calculation in which twice a critical angle where the light is totally reflected by the second surface inside the flat-plate member is subtracted from 90°.

2. The light guide plate according to claim 1, wherein
said conic-like solid shape is a geometrical pyramid, a petrosal shaped dip or triangular shaped trench, and
a plurality of the recessed portions are provided at least in a partial region on the first surface.

3. The light guide plate according to claim 2, wherein
at least two closest adjacent recessed portions are arranged with vertices of the bases facing each other on a straight line connecting the centers of the bases.

4. The light guide plate according to claim 2, wherein
a base of each of the recessed portions extends in one direction in the first surface, and
at least two adjacent recessed portions are arranged with the bases thereof paralleling each other in the first surface.

5. The light guide plate according to claim 1, wherein
said flat surface portion is provided with a light shielding member for shielding light.

6. The light guide plate according to claim 1, wherein
said member has an end portion in a mountain-peak shape having an apex angle of 90°, and
the end portion is provided with a reflection member for reflecting light.

7. A light source device comprising:
a light guide plate which has a flat-plate member provided with a first surface including a flat surface portion and a recessed portion in a conic-like solid shape and a second surface opposed to the first surface, the flat-plate member configured to receive light from the recessed portion, to propagate the light inside the flat-plate member while diffusing the light, and to radiate the diffused light from the second surface, wherein an angle between an inclined surface of the recessed portion and a normal line to the flat surface portion is smaller than a value obtained by calculation in which twice a critical angle where the light is totally reflected by the second surface inside the flat-plate member is subtracted from 90°; and
a light source provided below the recessed portion and configured to emit light which enters the light guide plate from the recessed portion.

8. The light source device according to claim 7, further comprising:
a reflection member provided surrounding the light source and configured to reflect the light toward the recessed portion.

9. The light source device according to claim 7, wherein
said conic-like solid shape is a geometrical pyramid, and
a plurality of the recessed portions are provided at least in a partial region on the first surface.

10. The light source device according to claim 7, wherein
at least two closest adjacent recessed portions are arranged with vertices of the bases facing each other on a straight line connecting the centers of the bases.

11. The light source device according to claim 7, wherein
said base of each of the recessed portions extends in one direction in the first surface, and
at least two adjacent recessed portions are arranged with the bases thereof paralleling each other in the first surface.

12. The light source device according to claim 7, wherein
said flat surface portion is provided with a light shielding member for shielding light.

13. The light source device according to claim 7, wherein
said member has an end portion in a mountain-peak shape having an apex angle of 90°, and
the end portion is provided with a reflection member for reflecting light.

14. A display apparatus comprising:
a light guide plate which has a flat-plate member provided with a first surface including a flat surface portion and a recessed portion in a conic-like solid shape and a second surface opposed to the first surface, the flat-plate member configured to receive light from the recessed portion, to propagate the light inside the flat-plate member while diffusing the light, and to radiate the diffused light from the second surface, wherein an angle between an inclined surface of the recessed portion and a normal line to the flat surface portion is smaller than a value obtained by calculation in which twice a critical angle where the light is totally reflected by the second surface inside the flat-plate member is subtracted from 90°;
a light source provided below the recessed portion and configured to emit light which enters the light guide plate from the recessed portion; and
a display unit configured to display by using a light source device having said light guide plate and said light source.

15. The display apparatus according to claim 14, further comprising:
a reflection member provided surrounding the light source and configured to reflect the light toward the recessed portion.
